(19) United States
(12) Patent Application Publication
(10) Pub. No.: US 2026/0267096 A1
(43) Pub. Date: Sep. 10, 2026

(54) OPTICAL PACKAGE MODULE AND MANUFACTURING METHOD THEREOF

(71) Applicant: SILICONWARE PRECISION INDUSTRIES CO., LTD., Taichung City (TW)

(72) Inventors: Chia-Pu LIANG, Taichung City (TW); Pei-Hsuan KE, Taichung City (TW); Jun-Yan LI, Taichung City (TW)

(73) Assignee: SILICONWARE PRECISION INDUSTRIES CO., LTD., Taichung City (TW)

(21) Appl. No.: 19/278,207

(22) Filed: Jul. 23, 2025

(30) Foreign Application Priority Data
Mar. 6, 2025 (TW) 114108345

(51) Int. Cl. G02B 6/42; G02B 6/43

(52) U.S. Cl. CPC G02B 6/4267; G02B 6/426; G02B 6/428; G02B 6/43

(57) ABSTRACT

An optical package module and a manufacturing method thereof are provided, in which a glass substrate having a first side and a second side opposite to the first side is provided, and a plurality of grooves are formed on the first side. Then, a plurality of optical engines are disposed in the plurality of grooves, and an electronic component is disposed on and electrically connected to the glass substrate. Therefore, the bending resistance is improved by using the glass substrate, thereby avoiding the electrical connection failure caused by warping.

### BACKGROUND

### 1. Technical Field

The present disclosure relates to a semiconductor package structure and a manufacturing method, and more particularly, to an optical package module and a manufacturing method thereof.

### 2. Description of Related Art

With the vigorous development of the electronics industry, electronic products are gradually moving forwards along the trend of multi-function and high performance. The application of the current fifth-generation (5G) communication technology has expanded to various fields such as the Internet of Things (IoT), Industrial Internet of Things (IIoT), cloud, artificial intelligence (AI), autonomous cars, and medical care. With the expansion of the application level, a large amount of data is generated that needs to be efficiently transmitted, computed, and stored. In particular, the demand for data transmission has emerged in large quantities, causing the industry to begin to use “light” instead of “electricity” as the carrier of data transmission, so as to increase the transmission capacity, efficiency, and distance, and to reduce energy consumption during the transmission process. In this context, co-packaged optical devices have become the development trend of future semiconductor and packaging technologies.

Referring to FIG. 1, which is a schematic cross-sectional view of a conventional co-packaged optical device 1, an optical engine 11 is disposed on a substrate 10, and the optical engine 11 includes an electronic chip 112 formed in a package structure 111 and a photonic chip 113 connected to the package structure 111, wherein a side end of the photonic chip 113 is connected to an optical fiber 14, and a shelf 15 is disposed underneath the junction of the photonic chip 113 and the optical fiber 14, so that optical signals are transmitted to the optical engine 11 for communication. At the same time, a switch chip 12 (e.g., a switch integrated circuit or switch IC) needs to be connected to the substrate 10 in addition so that the co-packaged optical device 1 can be used in an end product.

However, in the co-packaged optical device 1, the substrate 10 is prone to expanding and warping when exposed to heat, causing problems in the application of the end product.

Therefore, how to overcome the above-mentioned problems of the prior art has become an urgent issue to be solved.

### SUMMARY

In view of the above-mentioned shortcomings of the prior art, the present disclosure provides an optical package module, which comprises: a glass substrate having a first side, a second side opposite to the first side, and a plurality of grooves formed on the first side; a plurality of optical engines disposed in the plurality of grooves and electrically connected to the glass substrate; and an electronic component disposed on and electrically connected to the glass substrate.

The present disclosure also provides a method of manufacturing an optical package module, and the method comprises: providing a glass substrate having a first side and a second side opposite to the first side, and forming a plurality of grooves on the first side; disposing a plurality of optical engines in the plurality of grooves, and electrically connecting the plurality of optical engines to the glass substrate; and disposing an electronic component on the glass substrate, and electrically connecting the electronic component to the glass substrate.

In the aforementioned optical package module and method, the glass substrate is formed with a plurality of through-glass vias connecting the first side and the second side.

In the aforementioned optical package module and method, the plurality of grooves are formed on the first side and surround edges of the first side.

In the aforementioned optical package module and method, each of the plurality of optical engines includes an electronic chip formed in a package structure and a photonic chip disposed on and connected to the package structure. The photonic chip is electrically connected to the electronic chip via the package structure. The electronic chip is an electronic integrated circuit, and the photonic chip is a photonic integrated circuit.

In the aforementioned optical package module and method, the electronic component is a switch integrated circuit and is disposed on and connected to the first side of the glass substrate via a plurality of conductive components. In addition, the present disclosure further comprises forming a filling layer between the electronic component and the glass substrate to encapsulate the plurality of conductive components.

To sum up, in the optical package module and the manufacturing method thereof according to the present disclosure, a glass substrate is used instead of a plastic substrate, so that the bending resistance is improved to avoid the warpage of the substrate that causes the electrical connection failure. Further, grooves are formed on the surface of the glass substrate, and optical engines are disposed in the grooves, so that the overall thickness and the overall size of the optical package module are reduced. In addition, through-glass vias are formed in the glass substrate, so that an electronic component can be electrically connected to the through-glass vias. Therefore, the electronic component can be electrically connected to the glass substrate and a carrier structure subsequently connected underneath the glass substrate, thereby increasing the transmission speed of signals.

### BRIEF DESCRIPTION OF THE DRAWINGS

FIG. 1 is a schematic cross-sectional view of a conventional co-packaged optical device.

FIG. 2A to FIG. 2C are schematic cross-sectional views illustrating a method of manufacturing an optical package module according to the present disclosure.

FIG. 3 is a schematic top view of the optical package module of the present disclosure.

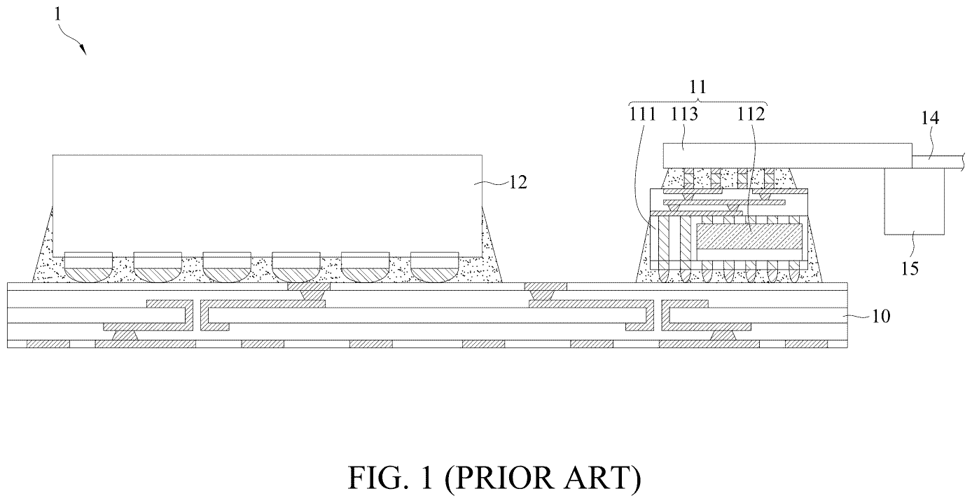

### DETAILED DESCRIPTION

Implementations of the present disclosure are illustrated using the following embodiments. One of ordinary skill in the art can readily appreciate other advantages and technical effects of the present disclosure upon reading the content of this specification.

It should be noted that the structures, ratios, sizes, etc. shown in the drawings appended to this specification are to be construed in conjunction with the disclosure of this specification in order to facilitate understanding of those skilled in the art. They are not meant to limit the implementations of the present disclosure, and therefore have no substantial technical meaning. Any modifications of the structures, changes of the ratio relationships, or adjustments of the sizes, are to be construed as falling within the range covered by the technical content disclosed herein to the extent of not causing changes in the technical effects created and the objectives achieved by the present disclosure. Meanwhile, terms such as “above,” “on,” “below,” “underneath,” “first,” “second,” “a,” “one,” and the like are for illustrative purposes, and are not meant to limit the scope in which the present disclosure can be implemented. Any variations or modifications to their relative relationships, without changes in the substantial technical content, should also to be regarded as within the scope in which the present disclosure can be implemented.

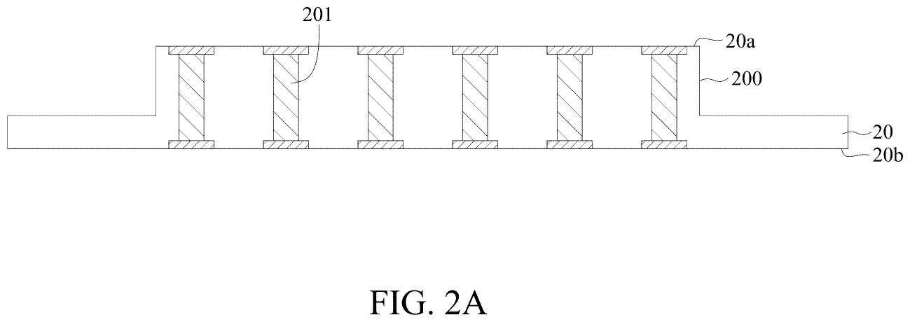

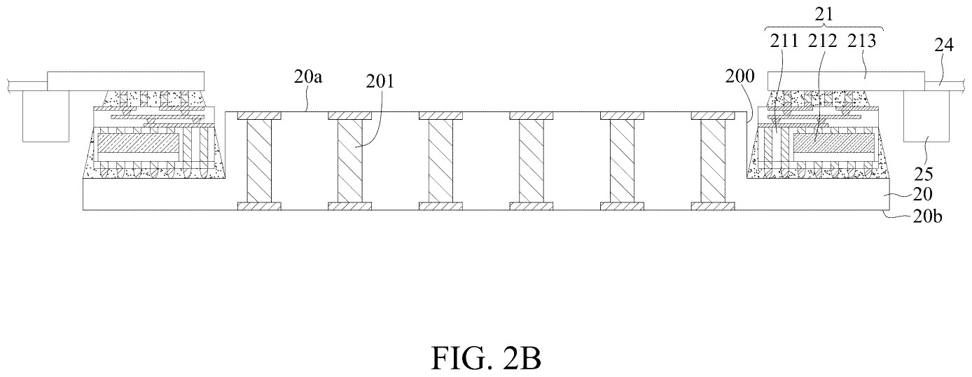

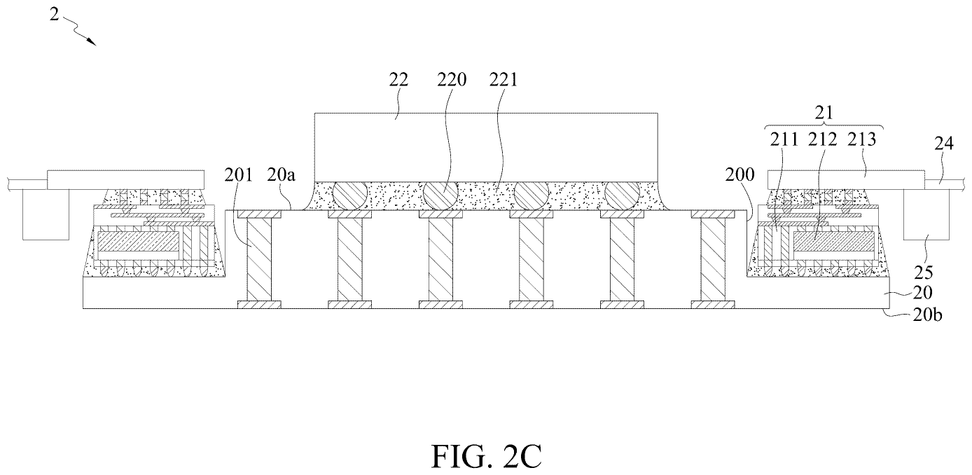

FIG. 2A to FIG. 2C are schematic cross-sectional views illustrating a method of manufacturing an optical package module 2 according to the present disclosure.

As shown in FIG. 2A, a glass substrate 20 is provided and has a first side 20a and a second side 20b opposite to the first side 20a, at least one groove 200 is formed on the first side 20a of the glass substrate 20 (this embodiment shows that a plurality of grooves 200 are formed on the first side 20a of the glass substrate 20), and a plurality of through-glass vias (TGVs) 201 connecting the first side 20a and the second side 20b are formed in the glass substrate 20.

The glass substrate 20 possesses unique performance characteristics, such as ultra-low planarity (extremely flat), improved thermal stability, and mechanical stability. Since the glass substrate 20 is very flat, the depth of focus for photolithography can be improved. As a result, for an equal area, the number of openings in the glass substrate 20 is significantly higher than the number of openings in a substrate made of organic material. Therefore, the spacing between the through-glass vias 201 can be less than 100 microns, enabling a higher interconnection density for an electronic component (a chip) subsequently placed on the glass substrate 20. In addition, the coefficient of thermal expansion of the glass substrate 20 is closer to the coefficient of thermal expansion of the electronic component, and the temperature tolerance of the glass substrate 20 is higher, which can reduce deformation and improve reliability.

In addition, at least one circuit layer (for instance, a redistribution layer [RDL]) can be formed on the first side 20a and/or the second side 20b of the glass substrate 20. The grooves 200 can be formed by methods such as laser cutting or tool cutting.

As shown in FIG. 2B, an optical engine 21 is disposed in each of the grooves 200.

The optical engine 21 includes an electronic chip 212 formed in a package structure 211 and a photonic chip 213 disposed on and connected to the package structure 211, wherein a side end of the photonic chip 213 is connected to an optical fiber 24, and a shelf 25 is disposed underneath the junction of the photonic chip 213 and the optical fiber 24, such that optical signals are transmitted to the optical engine 21 to communicate.

For example, the electronic chip 212 is an electronic integrated circuit (EIC) component, and the photonic chip 213 is a photonic integrated circuit (PIC) component. In addition, the optical engine 21 can be electrically connected to the glass substrate 20 via a plurality of conductive components.

As shown in FIG. 2C, at least one electronic component 22 is disposed on and electrically connected to the glass substrate 20.

For example, the electronic component 22 is a switch chip (e.g., a switch IC), and the electronic component 22 can be disposed on the first side 20a of the glass substrate 20 via a plurality of conductive components 220 and be electrically connected to the glass substrate 20. Further, a filling layer 221 can be formed between the electronic component 22 and the glass substrate 20 to encapsulate the plurality of conductive components 220, thereby obtaining the optical package module 2 of the present disclosure.

In an embodiment, the electronic component 22 can be electrically connected to the glass substrate 20 via the plurality of through-glass vias 201, so as to raise the transmission speed of signals.

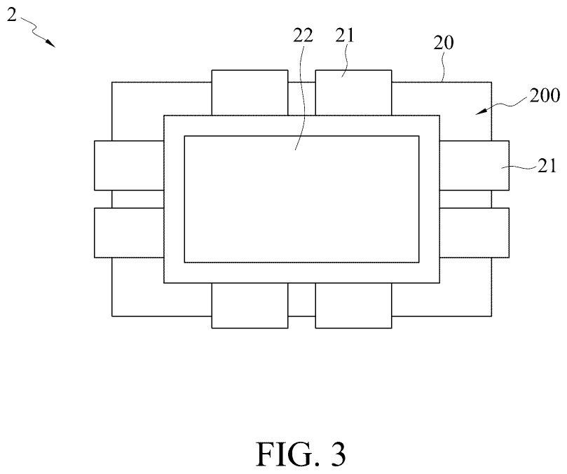

Please refer to FIG. 2C and FIG. 3 together, through the aforementioned manufacturing method, the present disclosure provides an optical package module 2, which comprises: a glass substrate 20 having grooves 200; an optical engine 21 disposed in each of the grooves 200; and an electronic component 22 disposed on the glass substrate 20.

The glass substrate 20 has a first side 20a and a second side 20b opposite to the first side 20a, and is formed with a plurality of through-glass vias 201, wherein the grooves 200 are formed on the first side 20a and surround edges of the first side 20a, and the plurality of optical engines 21 are disposed in the grooves 200, such that the optical engines 21 and the electronic component 22 can be electrically connected to the glass substrate 20 and a carrier structure subsequently connected underneath the glass substrate 20 via the through-glass vias 201.

Each of the optical engines 21 includes a package structure 211, an electronic chip 212 embedded in the package structure 211, and a photonic chip 213 disposed on and connected to the package structure 211, such that the photonic chip 213 is electrically connected to the electronic chip 212 via the package structure 211.

In summary, in the optical package module and the manufacturing method thereof according to the present disclosure, a glass substrate is used instead of a plastic substrate, so that the bending resistance is improved to avoid the warpage of the substrate that causes the electrical connection failure. Further, grooves are formed on the surface of the glass substrate, and optical engines are disposed in the grooves, so that the overall thickness and the overall size of the optical package module are reduced. In addition, through-glass vias are formed in the glass substrate, so that an electronic component can be electrically connected to the through-glass vias. Therefore, the electronic component can be electrically connected to the glass substrate and a carrier structure subsequently connected underneath the glass substrate, thereby increasing the transmission speed of signals.

The above embodiments are set forth to illustrate the principles of the present disclosure, and should not be interpreted as to limit the present disclosure. The above embodiments can be modified by one of ordinary skill in the art without departing from the scope of the present disclosure as defined in the appended claims. Therefore, the scope of protection of the right of the present disclosure should be listed as the following appended claims.

What is claimed is:

1. An optical package module, comprising:
a glass substrate having a first side, a second side opposite to the first side, and a plurality of grooves formed on the first side;
a plurality of optical engines disposed in the plurality of grooves and electrically connected to the glass substrate; and
an electronic component disposed on and electrically connected to the glass substrate.

2. The optical package module of claim 1, wherein the glass substrate is formed with a plurality of through-glass vias connecting the first side and the second side.

3. The optical package module of claim 1, wherein the plurality of grooves are formed on the first side and surround edges of the first side.

4. The optical package module of claim 1, wherein each of the plurality of optical engines includes an electronic chip formed in a package structure and a photonic chip disposed on and connected to the package structure.

5. The optical package module of claim 4, wherein the photonic chip is electrically connected to the electronic chip via the package structure.

6. The optical package module of claim 4, wherein the electronic chip is an electronic integrated circuit, and the photonic chip is a photonic integrated circuit.

7. The optical package module of claim 1, wherein the electronic component is a switch integrated circuit and is disposed on and connected to the first side of the glass substrate via a plurality of conductive components.

8. The optical package module of claim 7, further comprising: a filling layer formed between the electronic component and the glass substrate and encapsulating the plurality of conductive components.

9. A method of manufacturing an optical package module, comprising:
providing a glass substrate having a first side and a second side opposite to the first side, and forming a plurality of grooves on the first side;
disposing a plurality of optical engines in the plurality of grooves, and electrically connecting the plurality of optical engines to the glass substrate; and
disposing an electronic component on the glass substrate, and electrically connecting the electronic component to the glass substrate.

10. The method of claim 9, wherein the glass substrate is formed with a plurality of through-glass vias connecting the first side and the second side.

11. The method of claim 9, wherein the plurality of grooves are formed on the first side and surround edges of the first side.

12. The method of claim 9, wherein each of the plurality of optical engines includes an electronic chip formed in a package structure and a photonic chip disposed on and connected to the package structure.

13. The method of claim 12, wherein the photonic chip is electrically connected to the electronic chip via the package structure.

14. The method of claim 12, wherein the electronic chip is an electronic integrated circuit, and the photonic chip is a photonic integrated circuit.

15. The method of claim 9, wherein the electronic component is a switch integrated circuit and is disposed on and connected to the first side of the glass substrate via a plurality of conductive components.

16. The method of claim 15, further comprising: forming a filling layer between the electronic component and the glass substrate to encapsulate the plurality of conductive components.
